(19) United States
(12) Patent Application Publication
(10) Pub. No.: US 2010/0012104 A1
(43) Pub. Date: Jan. 21, 2010

(54) Ignition Timing System

(76) Inventors: Vince Scalia, East Haven, CT (US); Fred Carrado, JR., Guilford, CT (US)

Correspondence Address: ST. ONGE STEWARD JOHNSTON & REENS, LLC, 986 BEDFORD STREET, STAMFORD, CT, 06905-5619, US

(21) Appl. No.: 12/503,406

(22) Filed: Jul. 15, 2009

Related U.S. Application Data
(60) Provisional application No. 61/082,345, filed on Jul. 21, 2008.

(51) Int. Cl. F02P 7/067

(52) U.S. Cl. 123/617

(57) ABSTRACT

An ignition timing system and device with backup and multiple ignition timing systems. The ignition timing system has a rotating shaft with axially stacked first and second reluctors coupled to the rotating shaft. The first reluctor and second reluctor both have splines and corresponding sensors, whereby the sensors are mounted approximately 180 degrees apart from each other and are on different planes

### CROSS-REFERENCE TO RELATED APPLICATIONS

The present application claims the benefit under 35 U.S.C. §119 (e) of the Provisional Patent Application Ser. No. 61/082,345 filed Jul. 21, 2008.

### FIELD OF THE INVENTION

This invention relates to ignition timing devices, more particularly to ignition timing devices with backup or multiple ignition timing systems.

### BACKGROUND OF THE INVENTION

Automobiles, and more particularly, high performance automobiles and race cars, require rather complex ignition timing systems. These ignition timing systems are used to ensure that spark plugs ignite a compressed air-fuel mixture within the engine at an optimum position. As stakes are rather high in the auto racing industry, race car drivers, and drivers of high performance automobiles require that ignition timing systems perform without failure. To minimize failure of the ignition timing system, improved ignition timing systems may incorporate a backup sensor to ensure that the overall ignition timing system does not fail.

FIG. 1 depicts a typical configuration for a sensor incorporated into an engine component 100. Engine component 100 comprises a rotating shaft 111, which is coupled to oscillating piston elements (not shown) in the engine. Coupled to shaft 111 is reluctor (interrupter wheel) 112, which comprises splines 113. The position of the splines 113 on reluctor 112 corresponds to the compression positions of the piston elements. Engine component 100 also comprises a bell distributor housing 114 that partially

encompasses shaft 111. Sensor 115 is coupled to the inner wall of housing 114. As the shaft 111 rotates, the splines 113 of reluctor 112 also rotate. As a spline 113 passes sensor 115, the sensor 115 detects the spline and generates an electronic signal that is transmitted to an ignition box, which in turn ignites a spark plug associated with a particular piston.

Ignition timing systems are also known to incorporate dual timing sensors for ignition backup. As with the prior embodiment, FIG. 2 depicts an engine component 200 comprising a rotating shaft 211, a reluctor 212, and a bell distributor housing 214. FIG. 2 also illustrates that the ignition timing system further incorporates a pair of sensors 215, 216 that are coupled to the inner wall of housing 214. In a backup timing system, sensor 215 can be the primary sensor for ignition timing, while sensor 216 is the backup sensor. Both sensors are coupled to their own ignition box and generate a timing signal that is transmitted to the ignition box when either sensor is activated. Timing systems with backup sensors are known to use magnetic pickup sensors to generate the timing signal. In order to optimize the overall engine timing, the splines of reluctor 212 are shaped and positioned such that the primary sensor 215 generates an optimal timing signal, i.e. the proper advancing/retarding timing adjustments are achieved for each cylinder. Another aspect of timing systems with backup sensors is that since they utilize magnetic pickup sensors, the sensors need to be adequately spaced or isolated from one another such that sensors avoid cross-talking, i.e. the sensors do not interfere with one another. As a result, timing systems with backup sensors place the second sensor 216 180 degrees apart from the first sensor 215 on the same plane as the first sensor so that both sensors can detect the motion of reluctor 212 minimizing any possible interference. The deficiency with this design is that while the sensors are able to avoid interference the second sensor 216 is not in the proper position for optimal ignition timing. This is due to the fact that, as mentioned before, the splines of reluctor 212 are shaped and positioned for optimal performance with respect to primary sensor 215, and not the second sensor 216.

As a result, what is needed is an improved ignition timing system that incorporates a backup sensor that enables the backup sensor to have optimal ignition timing. It would also be beneficial to provide an improved ignition timing system that incorporates dual ignition systems that enable a primary and secondary ignition system to have unique or tailored timing, as well as to have an improved ignition timing system that minimizes and avoids cross-talk between the sensors.

The prior art fails to disclose these limitations. U.S. Pat. No. 6,784,658 (Kawagoe et al.), U.S. Pat. No. 6,405,687, (Arakawa et al.), U.S. Pat. No. 5,647,322 (Fukui et al.), U.S. Pat. No. 5,363,829 (Onisawa et al.), U.S. Pat. No. 4,773,381 (Koshida), U.S. Pat. No. 4,635,353 (Tamagne), U.S. Pat. No. 4,457,286 (Katayama et al.) have been considered and are hereby incorporated by reference into this application.

### BRIEF DESCRIPTION OF THE DRAWINGS

FIG. 1 is s a depiction of a prior art ignition timing system;

FIG. 2 is another depiction of a prior art ignition timing system;

FIG. 3 is a depiction of the inventive ignition timing system of the present invention.

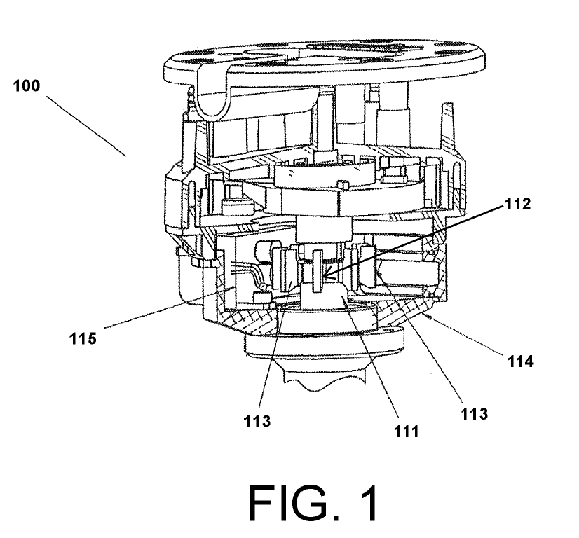

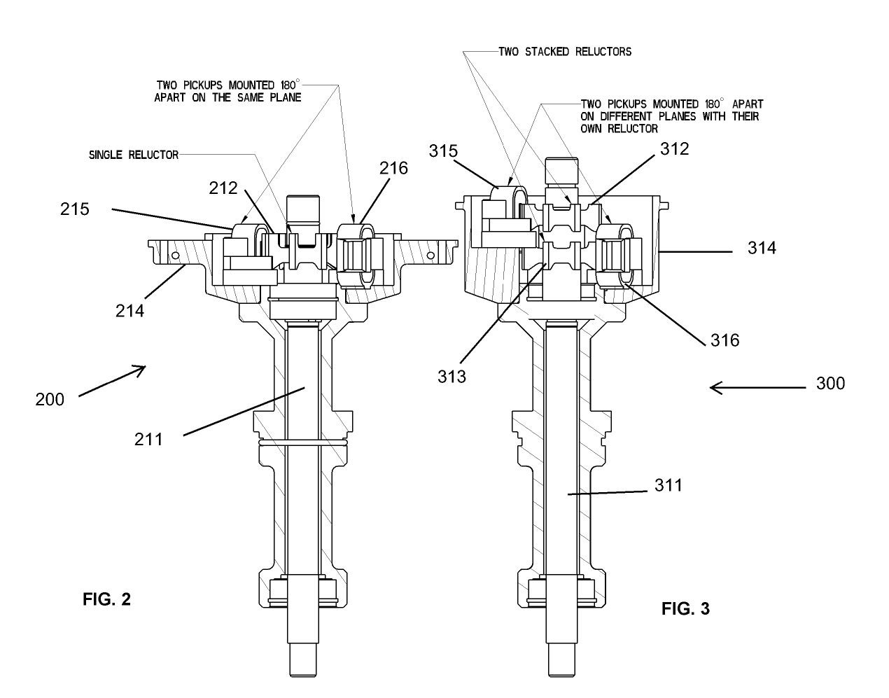

### DETAILED DESCRIPTION OF THE INVENTION

The present invention provides for an ignition timing system comprising a rotating shaft, a first reluctor coupled to the rotating shaft, the first reluctor having a corresponding first sensor, a second reluctor coupled to the rotating shaft, the second reluctor having a corresponding second sensor, wherein the first reluctor and second reluctor are axially stacked along the rotating shaft, and wherein both the first reluctor and the second reluctor have splines. The first sensor and the second sensor are mounted approximately 180 degrees apart from each other and are on different planes.

The first sensor detects the motion of a first reluctor and a second sensor detects the motion of a second reluctor. The first and second reluctors are axially spaced along a rotating shaft and form different planes with their corresponding sensors. The first reluctor comprises splines that are positioned and shaped for optimal ignition timing relative to the position of the first sensor. The second reluctor comprises splines that are positioned and shaped for optimal ignition timing relative to the position of the second sensor.

In one embodiment, the first sensor provides a primary ignition timing system, while the second sensor provides a backup ignition timing system. In another embodiment, the first sensor provides ignition timing for optimized ignition timing for the engine, while the second sensor provides alternatively tuned or identically tuned ignition timing for the engine.

Other embodiments may have the first sensor and second sensor be perpendicular or substantially perpendicular to the rotating shaft. The invention may have sensors selected from a group consisting of magnetic pickup sensors, hall-effect sensors, or optical sensors, or a combination thereof. Other sensors known in the art may also be used in the invention.

In preferred embodiments the first sensor and second sensor do not cross-talk with each other.

The ignition system may have the first reluctor and the second reluctor each have eight splines. This typically corresponds with an eight cylinder engine. The ignition system may also have the first reluctor and the second reluctor each have six splines or four splines. These configurations correspond to a six cylinder and a four cylinder engine, respectively.

The embodiments of the present invention may be used in race cars, trucks, motorcycles, and other such devices that require a combustion engine.

In another embodiment of the invention, the first sensor and said second sensor may be mounted approximately 90 degrees apart from each other and are on different planes.

In another embodiment, the ignition system further comprises magnetic pole pieces, wherein one magnetic pole piece will be positioned upward to properly alight with the upper stacked reluctor.

The invention functions by having the first sensor transmit a timing signal to the primary ignition circuit and the second sensor transmits a timing signal to the secondary ignition circuit. This is done each time a spline of the first reluctor and a spline of the second reluctor pass by the first sensor and second sensor respectively. The magnetic flux that results from the reluctors induces a signal that is picked up by the sensors.

The invention also comprises an embodiment whereby the first reluctor, first sensor, second reluctor, and second sensor are all located inside the housing of a distributor. In such an ignition system, the first sensor and the second sensor are mounted approximately 180 degrees apart from each other and are on different planes. Other orientations of the first sensor and the second sensor are also possible.

FIG. 3 depicts an embodiment of the present invention. As with the prior embodiments, FIG. 3 depicts an engine component 300 comprising a rotating shaft 311 and a bell distributor housing 314. This embodiment further incorporates first 312 and second 313 reluctors coupled to the shaft and corresponding sensors 315 and 316. The splines of first reluctor 312 are shaped and positioned for optimal ignition timing with respect to first sensor 315. The splines of second reluctor 313 are shaped and positioned for optimal ignition timing with respect to second sensor 316. The depiction in FIG. 3 illustrates sensors that are oriented 180 degrees relative to one another about the shaft axis. In the context of an ignition timing system with a backup sensor, both sensors generate a timing signal that is transmitted to a primary and backup ignition circuits respectively. The present embodiment can also be incorporated in a system that provides for differential timing between the two ignition systems. As such, the splines of first reluctor 312 are shaped and positioned for optimal ignition timing with respect to the primary ignition system, while the splines of second reluctor 313 are shaped and positioned for optimal ignition timing with respect to the alternative ignition system. In a preferred embodiment, the sensors 315 and 316 are magnetic pickup sensors. In this embodiment, the reluctors 312 and 313 and consequently the sensors are spaced axially relative to one another in order to prevent each set from cross-talking with each other. While magnetic pickup sensors are preferred, the present invention can also utilize other types of ignition timing sensors, such as hall-effect sensors or optical sensors.

Other embodiments of the invention may include the first reluctor and the second reluctor having wheels. The invention may involve the first sensor and second sensor not cross-taking with each other.

Other embodiments of the invention may include two separate redundant ignition circuits of which can be adjusted in relation to the other to provide for identical advancing or retarding timing adjustments for each of the cylinders, regardless of which of the two master ignition circuits is controlling the engine.

While the invention has been specifically described in connection with certain specific embodiments thereof, it is to be understood that this is by way of illustration and not of limitation and that various changes and modifications in form and details can be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. An ignition system for an engine comprising:
a rotating shaft,
a first reluctor coupled to the rotating shaft, the first reluctor having a corresponding first sensor,
a second reluctor coupled to the rotating shaft, the second reluctor having a corresponding second sensor,
wherein the first reluctor and second reluctor are axially stacked along the rotating shaft, and wherein both the first reluctor and the second reluctor have splines.

2. The ignition system of claim 1, wherein the first sensor and the second sensor are mounted approximately 180 degrees apart from each other and are on different planes.

3. The ignition system of claim 1, wherein the first sensor and the second sensor are perpendicular to the rotating shaft.

4. The ignition system of claim 1, wherein the first sensor and the second sensor are perpendicular to the rotating shaft, and wherein the first sensor and the second sensor are mounted approximately 90 degrees apart from each other and are on different planes.

5. The ignition system of claim 1, further comprising a primary ignition circuit and a secondary ignition circuit.

6. The ignition system of claim 5, wherein the first sensor transmits a timing signal to the primary ignition circuit and the second sensor transmits a timing signal to the secondary ignition circuit.

7. The ignition system of claim 1, wherein said splines of the first reluctor are shaped for optimal ignition timing with the first sensor.

8. The ignition system of claim 1, wherein said splines of the second reluctor are shaped for optimal ignition timing with the second sensor.

9. The ignition system of claim 1, wherein the first sensor is used as the primary ignition timing system.

10. The ignition system of claim 1, wherein the second sensor is used for a backup ignition timing system.

11. The ignition system of claim 1, wherein the first sensor provides optimized ignition timing for an engine, and the second sensor provides alternatively tuned timing for an engine.

12. The ignition system of claim 1, wherein the first sensor and the second sensor are selected from a group consisting of magnetic pickup sensors, hall-effect sensors, or optical sensors, or a combination thereof.

13. The ignition system of claim 1, wherein the first sensor and second sensor do not cross-talk with each other.

14. The ignition system of claim 1, wherein the first reluctor and second reluctor each have eight splines.

15. The ignition system of claim 1, wherein the first reluctor and second reluctor each have six splines.

16. The ignition system of claim 1, wherein the first reluctor and second reluctor each have four splines.

17. The ignition system of claim 1, wherein said ignition system is used in race cars.

18. The ignition system of claim 1, further comprising magnetic pole pieces, wherein one magnetic pole piece will be positioned upward to properly alight with the upper reluctor.

19. A distributor for an engine comprising:
a housing,
a rotating shaft located inside the housing,
a first reluctor coupled to the rotating shaft, the first reluctor having a corresponding first sensor,
a second reluctor coupled to the rotating shaft, the second reluctor having a corresponding second sensor,
wherein the first reluctor and second reluctor are axially stacked along the rotating shaft, and wherein both the first reluctor and the second reluctor have splines.

20. The ignition system of claim 19, wherein the first sensor and the second sensor are mounted approximately 180 degrees apart from each other and are on different planes.
